(19) United States
(12) Patent Application Publication
(10) Pub. No.: US 2024/0179170 A1
(43) Pub. Date: May 30, 2024

(54) SYSTEMS, METHODS, AND APPARATUSES FOR DYNAMICALLY DETERMINING SOFTWARE APPLICATION COVERAGE IN AN ELECTRONIC NETWORK

(71) Applicant: BANK OF AMERICA CORPORATION, Charlotte, NC (US)

(72) Inventors: Anthony Richard Bandos, Clarkston, MI (US); Nicholas Walter O'Reilly, Dallas, TX (US); Benjamin Tweel, Romeoville, IL (US); Marcus Raphael Matos, Richardson, TX (US)

(73) Assignee: BANK OF AMERICA CORPORATION, Charlotte, NC (US)

(21) Appl. No.: 18/071,299

(22) Filed: Nov. 29, 2022

(51) Int. Cl. H04L 9/40

(52) U.S. Cl. CPC H04L 63/1433; H04L 63/1475

(57) ABSTRACT

Systems, computer program products, and methods are described herein for dynamically determining software application coverage in an electronic network. The present invention is configured to determine a potential vulnerability associated with the plurality of application identifiers; generate a coverage score associated with each application identifier of the plurality of application identifiers, wherein the coverage score comprises an ability of at least one of the software application or the component to manage the potential vulnerability; generate a coverage ranking of the plurality of application identifiers, wherein the coverage ranking is based on the coverage score associated with each application identifier of the plurality of application identifiers; and store the coverage ranking of the plurality of application identifiers in a coverage ranking database, wherein the coverage ranking of the plurality of application identifiers is based on the potential vulnerability.

### FIELD OF THE INVENTION

The present invention embraces a system for dynamically determining software application coverage in an electronic network.

### BACKGROUND

Managers of electronic networks comprising different software applications and hardware components have a harder time than ever determining potential vulnerabilities of each software application and hardware component and how each software application or component may respond to a vulnerability if faced with the vulnerability in the future. A need, therefore exists, for a system to accurately, efficiently, and dynamically determine the coverage of each software application and component associated with an electronic network.

Applicant has identified a number of deficiencies and problems associated with dynamically determining software application coverage in an electronic network. Through applied effort, ingenuity, and innovation, many of these identified problems have been solved by developing solutions that are included in embodiments of the present disclosure, many examples of which are described in detail herein.

### SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

In one aspect, a system for dynamically determining software application coverage is provided. In some embodiments, the system may comprise: at least one processing device operatively coupled to the at least one memory device and the at least one communication device, wherein executing the computer-readable code is configured to cause the at least one processing device to: receive a plurality of application identifiers in an electronic network, wherein at least one application identifier of the plurality of application identifiers is associated with at least one of a software application or a component in the electronic network; determine a potential vulnerability associated with the plurality of application identifiers; generate a coverage score associated with each application identifier of the plurality of application identifiers, wherein the coverage score comprises an ability of at least one of the software application or the component to manage the potential vulnerability; generate a coverage ranking of the plurality of application identifiers, wherein the coverage ranking is based on the coverage score associated with each application identifier of the plurality of application identifiers; and store the coverage ranking of the plurality of application identifiers in a coverage ranking database, wherein the coverage ranking of the plurality of application identifiers is based on the potential vulnerability.

In some embodiments, the coverage score comprises at least one of a vulnerability scanning score, a publishing score, or a source score.

In some embodiments, the processing device is further configured to determine, based on the coverage ranking of the plurality of application identifiers, a high ranked application identifier subset, wherein the high ranked application identifier subset comprises at least one application identifier comprising an ability to overcome the potential vulnerability. In some embodiments, the processing device is further configured to: generate, based on the high ranked application identifier subset, a coverage ranking interface component, wherein the coverage ranking interface component comprises the high ranked application identifier subset; and transmit the coverage ranking interface component to a user device associated with the electronic network to configure a graphical user interface of the user device.

In some embodiments, the potential vulnerability is an attack.

In some embodiments, the processing device is further configured to: generate the potential vulnerability, wherein the potential vulnerability is a simulated attack on at least one software application or the component associated with each application identifier of the plurality of application identifiers; receive a simulated response from the at least one software application or the component associated with each application identifier, wherein the simulated response from the at least one software application or the component is a response based on the simulated attack; and generate the coverage ranking of the plurality of application identifiers based on the simulated response from the at least one software application or the component associated with each application identifier.

In another aspect, a computer program product for dynamically determining software application coverage is provided. In some embodiments, the computer program product may comprise at least one non-transitory computer-readable medium having computer-readable program code portions embodied therein, the computer-readable program code portions which when executed by a processing device are configured to cause the processor to: receive a plurality of application identifiers in an electronic network, wherein at least one application identifier of the plurality of application identifiers is associated with at least one of a software application or a component in the electronic network; determine a potential vulnerability associated with the plurality of application identifiers; generate a coverage score associated with each application identifier of the plurality of application identifiers, wherein the coverage score comprises an ability of at least one of the software application or the component to manage the potential vulnerability; generate a coverage ranking of the plurality of application identifiers, wherein the coverage ranking is based on the coverage score associated with each application identifier of the plurality of application identifiers; and store the coverage ranking of the plurality of application identifiers in a coverage ranking database, wherein the coverage ranking of the plurality of application identifiers is based on the potential vulnerability.

In some embodiments, the coverage score comprises at least one of a vulnerability scanning score, a publishing score, or a source score.

In some embodiments, the processing device is further configured to cause the processor to determine, based on the coverage ranking of the plurality of application identifiers, a high ranked application identifier subset, wherein the high ranked application identifier subset comprises at least one application identifier comprising an ability to overcome the potential vulnerability. In some embodiments, the processing device is further configured to cause the processor to: generate, based on the high ranked application identifier subset, a coverage ranking interface component, wherein the coverage ranking interface component comprises the high ranked application identifier subset; and transmit the coverage ranking interface component to a user device associated with the electronic network to configure a graphical user interface of the user device.

In some embodiments, the potential vulnerability is based on at least one of a common data environment list or a common weakness enumeration list.

In some embodiments, the potential vulnerability is an attack. In some embodiments, the processing device is further configured to cause the processor to: generate the potential vulnerability, wherein the potential vulnerability is a simulated attack on at least one software application or the component associated with each application identifier of the plurality of application identifiers; receive a simulated response from the at least one software application or the component associated with each application identifier, wherein the simulated response from the at least one software application or the component is a response based on the simulated attack; and generate the coverage ranking of the plurality of application identifiers based on the simulated response from the at least one software application or the component associated with each application identifier.

In another aspect, a computer-implemented method for dynamically determining software application coverage is provided. In some embodiments, the computer-implemented method may comprise: receiving a plurality of application identifiers in an electronic network, wherein at least one application identifier of the plurality of application identifiers is associated with at least one of a software application or a component in the electronic network; determining a potential vulnerability associated with the plurality of application identifiers; generating a coverage score associated with each application identifier of the plurality of application identifiers, wherein the coverage score comprises an ability of at least one of the software application or the component to manage the potential vulnerability; generating a coverage ranking of the plurality of application identifiers, wherein the coverage ranking is based on the coverage score associated with each application identifier of the plurality of application identifiers; and storing the coverage ranking of the plurality of application identifiers in a coverage ranking database, wherein the coverage ranking of the plurality of application identifiers is based on the potential vulnerability.

In some embodiments, the coverage score comprises at least one of a vulnerability scanning score, a publishing score, or a source score.

In some embodiments, the computer-implemented method further comprises determining, based on the coverage ranking of the plurality of application identifiers, a high ranked application identifier subset, wherein the high ranked application identifier subset comprises at least one application identifier comprising an ability to overcome the potential vulnerability. In some embodiments, the computer-implemented method further comprises: generating, based on the high ranked application identifier subset, a coverage ranking interface component, wherein the coverage ranking interface component comprises the high ranked application identifier subset; and transmitting the coverage ranking interface component to a user device associated with the electronic network to configure a graphical user interface of the user device.

In some embodiments, the potential vulnerability is based on at least one of a common data environment list or a common weakness enumeration list.

In some embodiments, the potential vulnerability is an attack.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIGS. 1A-1C illustrates technical components of an exemplary distributed computing environment dynamically determining software application coverage in an electronic network, in accordance with an embodiment of the invention;

FIG. 2 illustrates a process flow for dynamically determining software application coverage in an electronic network, in accordance with an embodiment of the invention;

FIG. 3 illustrates a process flow for generating and transmitting the coverage ranking interface component to a user device, in accordance with an embodiment of the invention; and

FIG. 4 illustrates a process flow for generating the coverage ranking of the plurality of application identifiers based on a simulated response, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As described in further detail herein, the present invention provides a solution to the above-referenced problems in the field of technology by generating an accurate, efficient, and dynamic coverage determination system for determining the coverage of software applications and components associated with an electronic network. Such a system (i.e., a coverage determination system) solves at least the technical problems in accurately, efficiently, and dynamically determining whether software applications and components can manage (e.g., overcome, solve, and/or mitigate) a potential vulnerability (e.g., a cyber-attack). Such a coverage determination may then be used to generate a coverage score for each software application or component associated with the electronic network, where the coverage score may be used to rank each of the software applications or components for future potential vulnerabilities. In this manner, the coverage determination system may be used by a user of the electronic network to choose a software application or component to manage a vulnerability at a future time without delay or inaccurate determinations. Additionally, such a coverage ranking may be dynamically updated based on new potential vulnerabilities being identified or generated and the new potential vulnerabilities being tested in the software applications and components.

Accordingly, the present invention works by receiving a plurality of application identifiers in an electronic network, wherein at least one application identifier of the plurality of application identifiers is associated with at least one software application or at least one component in the electronic network. The coverage determination system may additionally determine a potential vulnerability associated with the plurality of application identifiers and generate a coverage score associated with each application identifier of the plurality of application identifiers, wherein the coverage score comprises an ability of at least the software application or the component to manage the potential vulnerability. The coverage determination system may further generate a coverage ranking of the plurality of application identifiers, wherein the coverage ranking is based on the coverage score associated with each application identifier of the plurality of application identifiers and store the coverage ranking of the plurality of application identifiers in a coverage ranking database, wherein the coverage ranking of the plurality of application identifiers is based on the potential vulnerability.

What is more, the present invention provides a technical solution to a technical problem. As described herein, the technical problem includes the accurate, efficient and dynamic determination of software application and component coverage in an electronic network for identified potential vulnerabilities. The technical solution presented herein allows for a coverage determination system that provides an accurate, efficient, and dynamic determination of software and component coverage in the electronic network. In particular, the coverage determination system is an improvement over existing solutions to the coverage determination problems identified herein, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

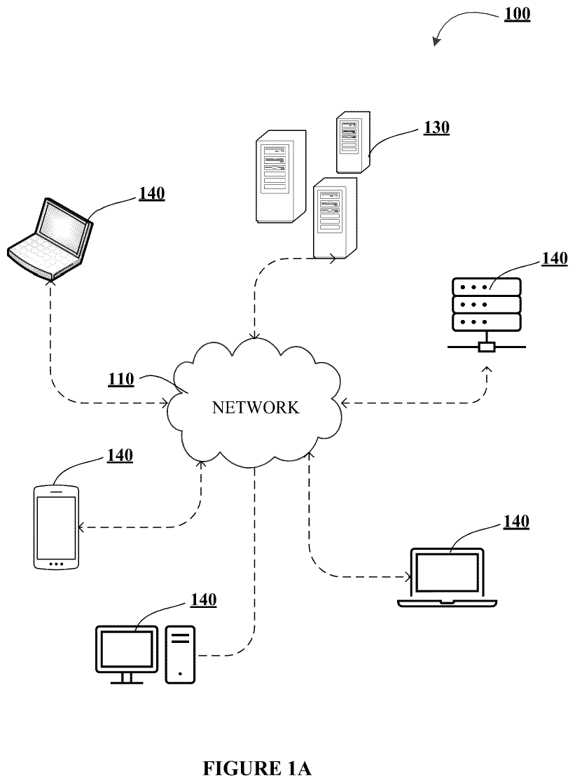

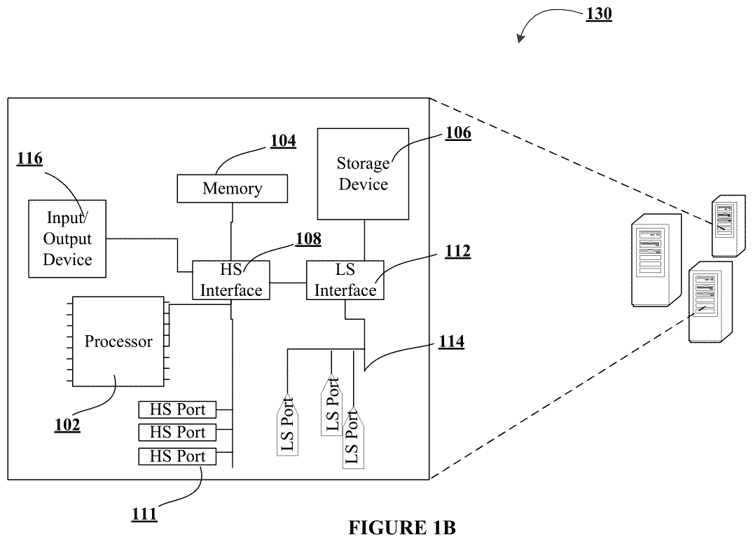

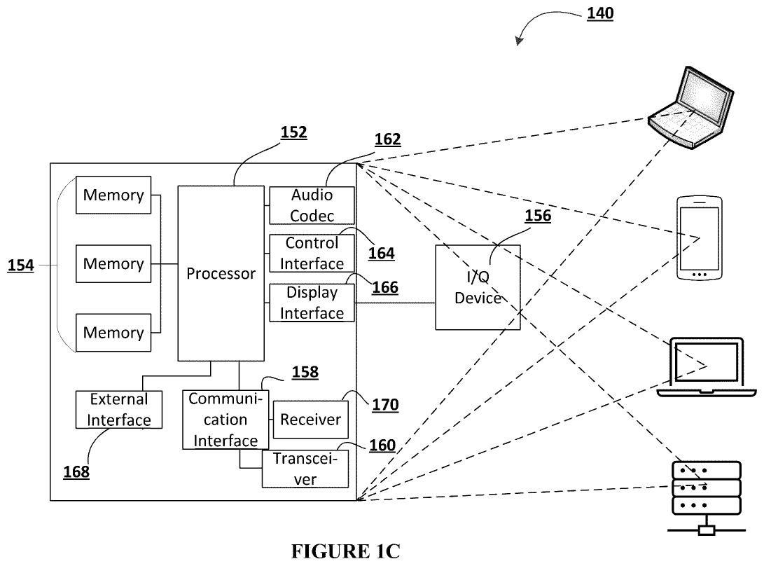

FIGS. 1A-1C illustrate technical components of an exemplary distributed computing environment for dynamically determining software application coverage in an electronic network 100, in accordance with an embodiment of the invention. As shown in FIG. 1A, the distributed computing environment 100 contemplated herein may include a system 130 (i.e., a coverage determination system), an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the inventions described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the invention. As shown in FIG. 1B, the system 130 may include a processor 102, memory 104, input/output (I/O) device 116, and a storage device 106. The system 130 may also include a high-speed interface 108 connecting to the memory 104, and a low-speed interface 112 (shown as “LS Interface”) connecting to low speed bus 114 (shown as “LS Port”) and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 (shown as “HS Interface”) is coupled to memory 104, input/output (I/O) device 116 (e.g., through a graphics processor or accelerator), and to high-speed expansion ports 111 (shown as “HS Port”), which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the invention. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation—and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

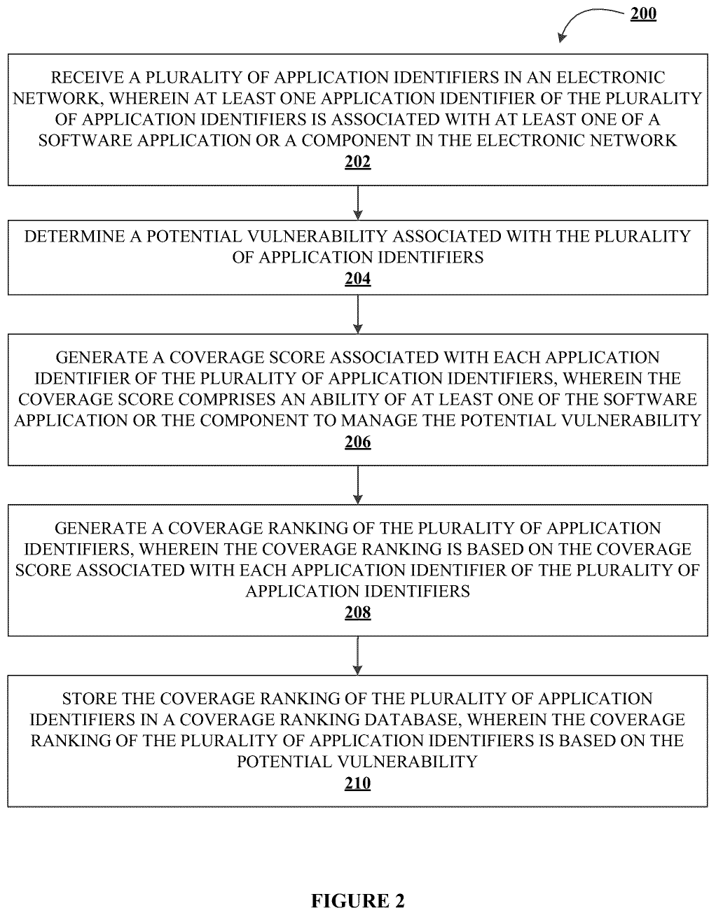

FIG. 2 illustrates a process flow 200 for dynamically determining software application coverage in an electronic network, in accordance with an embodiment of the invention. In some embodiments, a system (e.g., similar to one or more of the systems described herein with respect to FIGS. 1A-1C) may perform one or more of the steps of process flow 200. For example, a coverage determination system (e.g., the system 130 described herein with respect to FIG. 1A-1C) may perform the steps of process 200.

As shown in block 202, the process flow 200 may include the step of receiving a plurality of application identifiers in an electronic network, wherein at least one application identifier of the plurality of application identifiers is associated with at least one of a software application or a component in the electronic network. In some embodiments, the coverage determination system may receive the plurality of application identifiers in an electronic network from a database associated with the electronic network, where the database may comprise a plurality of application identifiers associated with the applications using the network. In some embodiments, the database may comprise a plurality of application signatures that have used the electronic network to communicate, and such application signatures may comprise associated application identifiers which are used to identify each application communicating using the electronic network. In some embodiments, the electronic network itself may store each of the application signatures as the applications communicate across and within the electronic network. In some embodiments, the application identifiers associated with the electronic network may be identified by a web-scraper that is designed to scrape the web to determine other, potential software applications and components not currently using the electronic network to communicate. In this manner, the coverage determination system may determine the coverage abilities for all software applications and components available to the electronic network.

In some embodiments, the software applications and/or components associated with the application identifiers may be stored within the entity's electronic network which may comprise a private network, a public network, and/or the like.

In some embodiments, the at least one application identifier of the plurality of application identifiers may be associated with at least one software application and/or a component, such as a hardware component, associated with the electronic network. For instance, the coverage determination system-through the electronic network—may identify each application using the electronic network for communication as well as any component (e.g., hardware component) associated with the electronic network and carrying out functions of the electronic network. For instance, the hardware components associated with the electronic network may include, but is not limited to, processors (e.g., processors 102 and/or processors 152), memories (e.g., memory 104 and/or memories 154), user devices (e.g., user devices 140), storage devices (e.g., storage device 106 and/or storage device 156), input/output devices (e.g., input/output devices 116 and/or I/O Device 156), ports (e.g., HS Ports 111 and/or LS Ports 114), interfaces (e.g., HS interface 108, LS interface 112, control interface 164, display interface 166, communication interface 158, external interface 168, and/or the like), codecs (e.g., audio codec 162), receivers/transceivers (e.g., receiver 170 and/or transceiver 160), and/or the like. Such a software application may comprise at least one of a system software, a general-purpose software application, a custom software, a web browser, a presentation software, a spreadsheet software, a word processor software, a graphic software, a database software, an education software, a multimedia software, an information software, a content access software, and/or the like. As described above, the coverage determination system may generate a web-scraper to determine and collect data regarding software applications and components not currently associated with the electronic network, where such data may comprise application identifiers which can in turn be used by the coverage determination system to determine each software applications and each component's ability to manage potential vulnerabilities, which is described in further detail below.

As shown in block 204, the process flow 200 may include the step of determining a potential vulnerability associated with the plurality of application identifiers. In some embodiments, the coverage determination system may determine the potential vulnerability associated with an application identifier by basing its determination on at least one of a common data environment list or a common weakness enumeration list. For instance, the common data environment list may comprise data of a list of vulnerabilities faced by specific components, infrastructure environments, and/or the like, where each vulnerability listed in the common data environment list may be from across different electronic networks. For instance, the common data environment list may be added to, updated, and/or the like, from a plurality of entities comprising different electronic networks, where each vulnerability has impacted at least one electronic network in the industry and has been reported an entity. Similarly, the common weakness enumeration list may comprise a list of software and hardware weaknesses/vulnerabilities that have impacted the industry and have been reported by at least one entity. In some embodiments, the coverage determination system may generate a web scraper to determine each of the common data environment list and/or the common weakness enumeration list and any associated updates since the previous web scrape.

In some embodiments, the potential vulnerability may be an attack, such as a cyber attack which the electronic network associated with the coverage determination system was impacted by and/or the coverage determination system was made aware by a different entity reporting the attack. In some embodiments, the coverage determination system may generate and employ a web scraper to determine any potential attacks that have impacted other electronic networks (and other applications and components) in the industry.

As shown in block 206, the process flow 200 may include the step of generating a coverage score associated with each application identifier of the plurality of application identifiers, wherein the coverage score comprises an ability of at least one of the software application or the component to manage the potential vulnerability. In some embodiments, the coverage determination system may generate the coverage score for each application identifier by generating the coverage score for each software application and/or component. For instance, the coverage score for each software application and/or component may be based on a determination of whether each application and/or component associated with each application identifier could manage each potential vulnerability identified for each application identifier. As used herein, the terms “manage,” “management,” and “managed” may refer to a software application and/or a component's ability to overcome, solve, and/or mitigate the potential vulnerability.

By way of non-limiting example, the coverage score may comprise a numerical scoring of each software application or component to manage the potential vulnerability, whereby the numerical scoring may comprise a percentage (e.g., the closer to 100%, the more likely the software application or component is to completely overcome or solve the potential vulnerability). In some embodiments, the coverage score may comprise a numerical value from 0 to 10, wherein the closer to ten, the higher the likelihood the software application or component associated with the application identifier will completely overcome or solve the potential vulnerability. In some embodiments, the coverage score may further comprise data regarding each software applications or component's timestamp in managing the potential vulnerability and each software applications or component's ability to manage the potential vulnerability before other software applications or components are impacted by the potential vulnerability.

In some embodiments, the coverage score may comprise at least one of a vulnerability scanning score, a publishing score, a source score, and/or the like. By way of non-limiting example, the vulnerability scanning score may be based on the vendors (or creators) of the software applications and/or components, and which vendors are publishing detections earliest for the potential vulnerabilities. By way of non-limiting example, the publishing score may be based on which vendors (e.g., creators of software applications and/or components) are publishing updates to the software applications or components the quickest to overcome, solve, and/or mitigate potential vulnerabilities. By way of non-limiting example, the source score may be based on the overall vendor score for each software application or component, where such a vendor score may be based on factors including but not limited to a vendor's quickness in responding to queries from clients, a vendor's client feedback, vendor's agreements, vendor's success rates for each software application and/or component, vendor rate for software applications or components, vendor expertise, and/or the like.

In some embodiments, the coverage score may comprise a combination of scores applied for each application identifier such as a combination of the vulnerability scanning score, the publishing score, the source score, and/or the like. In some embodiments, each of the vulnerability scanning score, the publishing score, and the source score may be evenly weighted such that each score (e.g., the vulnerability scanning score, the publishing score, and the source score) may be considered equally to determine the overall coverage score. In some embodiments, and similar to the description above, the coverage score may comprise a percentage score from 0% to 100% or a numerical score of 0 to 10, where the higher the percentage score and/or the higher the numerical score, the higher the likelihood the software application or component may overcome or solve the potential vulnerability.

In some embodiments, and as described above, for the software applications and components that are not currently associated with the electronic network, the coverage determination system may likewise use such data (e.g., a vulnerability scanning score, a publishing score, a source score, and/or the like) to determine a coverage score for the software applications and components.

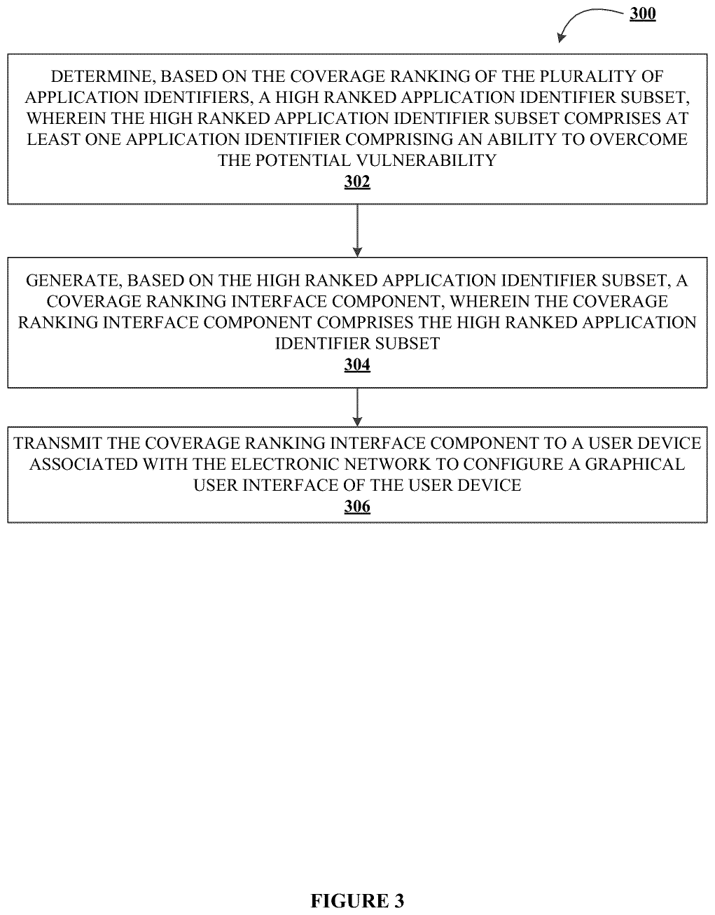

As shown in block 208, the process flow 200 may include the step of generating a coverage ranking of the plurality of application identifiers, wherein the coverage ranking is based on the coverage score associated with each application identifier of the plurality of application identifiers. In some embodiments, the coverage determination system may generate the coverage ranking of each application identifier based on the coverage score for each application identifier, where the higher the coverage score, the higher the coverage ranking of the application identifier. In this manner, the coverage determination system may determine a plurality of application identifiers which comprise the highest coverage rankings, where the highest coverage rankings and associated applications may be considered for use in overcoming, solving, and/or mitigating a potential or future vulnerability. In some embodiments, the coverage determination system may generate a coverage ranking interface component to show a plurality of high ranked application identifiers to a user of the coverage determination system. Such a generation and transmission of the coverage ranking interface component is discussed in further detail below with respect to FIG. 3.

As shown in block 210, the process flow 200 may include the step of storing the coverage ranking of the plurality of application identifiers in a coverage ranking database, wherein the coverage ranking of the plurality of application identifiers is based on the potential vulnerability. In some embodiments, the coverage determination system may store each coverage ranking for the plurality of application identifiers in a coverage ranking database, where the coverage ranking database may store and organize each coverage ranking and associated application identifier based on the potential vulnerability. In this manner, a user of the coverage determination system may quickly query and call-up the coverage rankings of each application identifier for a specific potential vulnerability and may quickly determine the best (e.g., highest ranked application identifier of the coverage rankings) for a specific potential vulnerability, such as a current vulnerability currently faced by an electronic network of the user.

FIG. 3 illustrates a process flow 300 for generating and transmitting the coverage ranking interface component to a user device, in accordance with an embodiment of the invention. In some embodiments, a system (e.g., similar to one or more of the systems described herein with respect to FIGS. 1A-1C) may perform one or more of the steps of process flow 300. For example, a coverage determination system (e.g., the system 130 described herein with respect to FIG. 1A-1C) may perform the steps of process 300.

As shown in block 302, the process flow 300 may include the step of determining, based on the coverage ranking of the plurality of application identifiers, a high ranked application identifier subset, wherein the high ranked application identifier subset comprises at least one application identifier comprising an ability to overcome the potential vulnerability. In some embodiments, the coverage determination system may determine the high ranked application identifier subset based on the coverage rankings generated in block 208.

For instance, and as discussed above, the coverage determination system may generate a plurality of coverage rankings associated with a plurality of application identifiers based on the respective potential vulnerability. By way of non-limiting example, the coverage determination system may determine, from the coverage rankings of the plurality of application identifiers, a high ranked application identifier subset which may comprise a subset of the highest ranked coverage rankings for a specific potential vulnerability. For instance, the coverage determination system may determine a ratio or specific number of the application identifiers to be comprised within the high ranked application identifier subset-such as the top 10% of the application identifiers, the top 10 of the application identifiers, the top 25% of the application identifiers, and/or the like.

In some embodiments, the ratio or specific number of application identifiers for the high ranked application identifier subset may be pre-determined by the coverage determination system itself, by a manager of the coverage determination system, by a client of the coverage determination system (e.g., the entity associated with the electronic network the coverage determination system is analyzing, and/or a user of the coverage determination system such as a user associated with the client of the coverage determination system), and/or the like. In this manner, the coverage determination system may generate the high ranked application identifier subset to comprise a subset of the application identifiers associated with the coverage rankings that show a higher likelihood that the associated software application and/or components would solve or overcome a specific potential vulnerability. For instance, each high ranked application identifier subset may be associated with a specific potential vulnerability, and the coverage determination system may generate a high ranked application identifier subset for each potential vulnerability the electronic network (and its associated or unassociated software applications and components) may face.

As shown in block 304, the process flow 300 may include the step of generating, based on the high ranked application identifier subset, a coverage ranking interface component, wherein the coverage ranking interface component comprises the high ranked application identifier subset. In some embodiments, the coverage determination system may generate the coverage ranking interface component based on the high ranked application identifier subset, where the coverage ranking interface component may comprise the data of the high ranked application identifier subset including but not limited to the application identifiers, the coverage rankings, and the coverage scores of each application identifier.

As shown in block 306, the process flow 300 may include the step of transmitting the coverage ranking interface component to a user device associated with the electronic network to configure a graphical user interface of the user device. By way of non-limiting example, the coverage determination system may generate the coverage ranking interface component to be transmitted to a user device associated with the coverage determination system-such as a user device associated with a manager of the coverage determination system, a user device associated with a client of the coverage determination system, a user device associated with a user of the client, and/or the like—where the coverage ranking interface component may configure the graphical user interface of the user device to display at least the application identifiers, the coverage rankings, and the coverage scores of each application identifier.

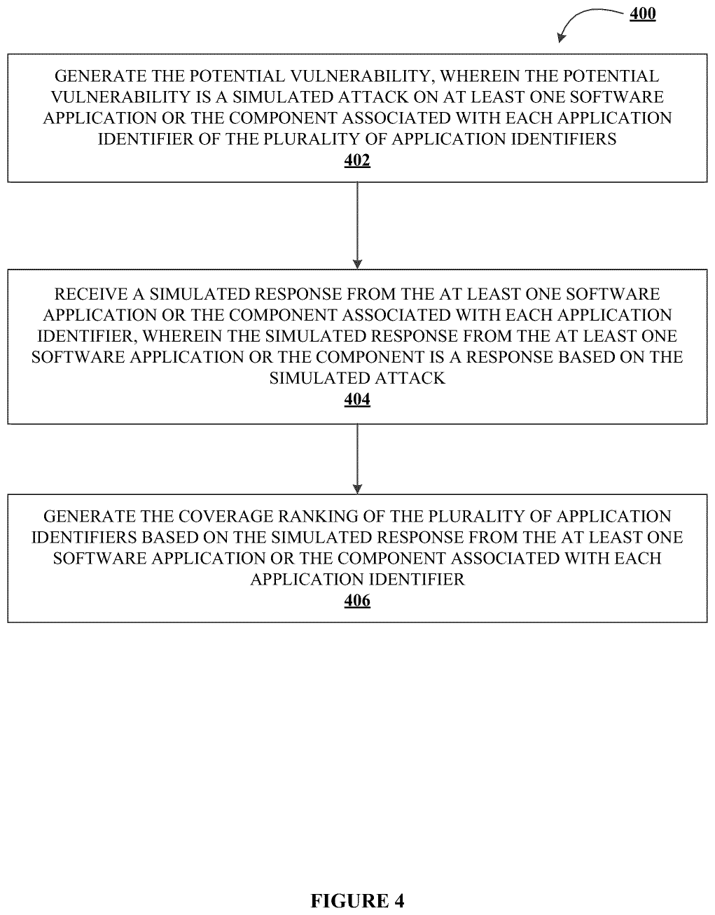

FIG. 4 illustrates a process flow 400 for generating the coverage ranking of the plurality of application identifiers based on a simulated response, in accordance with an embodiment of the invention. In some embodiments, a system (e.g., similar to one or more of the systems described herein with respect to FIGS. 1A-1C) may perform one or more of the steps of process flow 400. For example, a coverage determination system (e.g., the system 130 described herein with respect to FIG. 1A-1C) may perform the steps of process 400.

As shown in block 402, the process flow 400 may include the step of generating the potential vulnerability, wherein the potential vulnerability is a simulated attack on at least one software application or one component associated with each application identifier of the plurality of application identifiers. In some embodiments, the coverage determination system may generate the potential vulnerability as a simulated attack on a software application or component associated with an application identifier associated with the entity network (or unassociated with the electronic network, such as a software application or component not currently associated with the electronic network but identified by a web-scraping). Such a simulated attack may comprise a simulated cyber attack which may be simulated to parallel and/or copy a real cyber-attack. Such a simulated attack, as used herein, may emulate a real cyber-attack which is generated by an entity associated with the coverage determination system (e.g., a manager of the coverage determination system, a user of the coverage determination system, and/or a client of the coverage determination system) to test its own network, infrastructure, software applications, components, and/or the like. In some embodiments, the coverage determination system may test unassociated software applications and components in order to determine whether any unassociated software applications or components would manage the cyber-attack better than the current, associated software applications or components.

As shown in block 404, the process flow 400 may include the step of receiving a simulated response from the at least one software application or the component associated with each application identifier, wherein the simulated response from the at least one software application or the component is a response based on the simulated attack. In some embodiments, the coverage determination system may receive a simulated response from at least one of the electronic network, the infrastructure components associated with the electronic network, the software applications, the components, and/or the like, where the simulated response comprises a response based on the simulated attack. Such responses may comprise an indication of whether at least one of the software application or the component associated with each application identifier was able to manage the simulated attack. In some embodiments, the indication of whether at least one of the software application or the component associated with the application identifier managed the simulated attack may be a binary response (e.g., a 1 may indicate the simulated attack was managed and a 0 may indicate the simulated attack was not managed), a positive or negative response, and/or the like. In some embodiments, the simulated response may further comprise a timestamp of how long the software application or component took to manage the simulated attack, an identification of any other software applications or components the simulated attack impacted before the software application or component associated with the application identifier managed the simulated attack, and/or the like.

As shown in block 406, the process flow 400 may include the step of generating the coverage ranking of the plurality of application identifiers based on the simulated response from the at least one software application or the component associated with each application identifier. In some embodiments, the coverage determination system may generate a coverage ranking for each application identifier based on the simulated response from the simulated attack. Such a coverage ranking may be based on each software application or component's simulated response including a binary scoring and/or indication of whether the software application or component managed the simulated attack, the timestamp for the management of the simulate attack, the impact of other software applications or components during the simulated attack, and/or the like. By way of non-limiting example, each of the binary scoring and/or indication the simulated attack was managed, the timestamp, and the impact of other software applications or components may be weighted equally to determine the coverage ranking. In some embodiments, the binary scoring and/or indication the simulated attack was managed may be weighted more than the timestamp and the impact of other software applications or components in determining the coverage ranking.

In some embodiments, the coverage determination system may determine a higher coverage ranking for a software application or component associated with an application identifier in the instance where the software application or the component manage the simulated attack, manage the simulated attack in the shortest amount of time, and manage the simulated attack before any other software applications or components are impacted by the simulated attack. Similarly, and as described above, such a coverage ranking of each of the application identifiers for the potential vulnerability associated with simulated attack may be used to generate and transmit a coverage ranking interface component to a user device. Additionally, such a coverage ranking generated based on the simulated attack may be stored in the coverage ranking database, such that the coverage ranking storage is based on the potential vulnerability/simulated attack.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These computer-executable program code portions execute via the processor of the computer and/or other programmable data processing apparatus and create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for dynamically determining software application coverage, the system comprising:
a memory device with computer-readable program code stored thereon;
at least one processing device operatively coupled to the at least one memory device and the at least one communication device, wherein executing the computer-readable code is configured to cause the at least one processing device to:
receive a plurality of application identifiers in an electronic network, wherein at least one application identifier of the plurality of application identifiers is associated with at least one of a software application or a component in the electronic network;
determine a potential vulnerability associated with the plurality of application identifiers;
generate a coverage score associated with each application identifier of the plurality of application identifiers, wherein the coverage score comprises an ability of at least one of the software application or the component to manage the potential vulnerability;
generate a coverage ranking of the plurality of application identifiers, wherein the coverage ranking is based on the coverage score associated with each application identifier of the plurality of application identifiers; and
store the coverage ranking of the plurality of application identifiers in a coverage ranking database, wherein the coverage ranking of the plurality of application identifiers is based on the potential vulnerability.

2. The system of claim 1, wherein the coverage score comprises at least one of a vulnerability scanning score, a publishing score, or a source score.

3. The system of claim 1, wherein the processing device is further configured to determine, based on the coverage ranking of the plurality of application identifiers, a high ranked application identifier subset, wherein the high ranked application identifier subset comprises at least one application identifier comprising an ability to overcome the potential vulnerability.

4. The system of claim 3, wherein the processing device is further configured to:
generate, based on the high ranked application identifier subset, a coverage ranking interface component, wherein the coverage ranking interface component comprises the high ranked application identifier subset; and
transmit the coverage ranking interface component to a user device associated with the electronic network to configure a graphical user interface of the user device.

5. The system of claim 1, wherein the potential vulnerability is based on at least one of a common data environment list or a common weakness enumeration list.

6. The system of claim 1, wherein the potential vulnerability is an attack.

7. The system of claim 1, wherein the processing device is further configured to:
generate the potential vulnerability, wherein the potential vulnerability is a simulated attack on at least one software application or the component associated with each application identifier of the plurality of application identifiers;
receive a simulated response from the at least one software application or the component associated with each application identifier, wherein the simulated response from the at least one software application or the component is a response based on the simulated attack; and
generate the coverage ranking of the plurality of application identifiers based on the simulated response from the at least one software application or the component associated with each application identifier.

8. A computer program product for dynamically determining software application coverage, wherein the computer program product comprises at least one non-transitory computer-readable medium having computer-readable program code portions embodied therein, the computer-readable program code portions which when executed by a processing device are configured to cause the processor to:
receive a plurality of application identifiers in an electronic network, wherein at least one application identifier of the plurality of application identifiers is associated with at least one of a software application or a component in the electronic network;
determine a potential vulnerability associated with the plurality of application identifiers;
generate a coverage score associated with each application identifier of the plurality of application identifiers, wherein the coverage score comprises an ability of at least one of the software application or the component to manage the potential vulnerability;
generate a coverage ranking of the plurality of application identifiers, wherein the coverage ranking is based on the coverage score associated with each application identifier of the plurality of application identifiers; and
store the coverage ranking of the plurality of application identifiers in a coverage ranking database, wherein the coverage ranking of the plurality of application identifiers is based on the potential vulnerability.

9. The computer program product of claim 8, wherein the coverage score comprises at least one of a vulnerability scanning score, a publishing score, or a source score.

10. The computer program product of claim 8, wherein the processing device is further configured to cause the processor to determine, based on the coverage ranking of the plurality of application identifiers, a high ranked application identifier subset, wherein the high ranked application identifier subset comprises at least one application identifier comprising an ability to overcome the potential vulnerability.

11. The computer program product of claim 10, wherein the processing device is further configured to cause the processor to:
generate, based on the high ranked application identifier subset, a coverage ranking interface component, wherein the coverage ranking interface component comprises the high ranked application identifier subset; and
transmit the coverage ranking interface component to a user device associated with the electronic network to configure a graphical user interface of the user device.

12. The computer program product of claim 8, wherein the potential vulnerability is based on at least one of a common data environment list or a common weakness enumeration list.

13. The computer program product of claim 8, wherein the potential vulnerability is an attack.

14. The computer program product of claim 13, wherein the processing device is further configured to cause the processor to:
generate the potential vulnerability, wherein the potential vulnerability is a simulated attack on at least one software application or the component associated with each application identifier of the plurality of application identifiers;
receive a simulated response from the at least one software application or the component associated with each application identifier, wherein the simulated response from the at least one software application or the component is a response based on the simulated attack; and
generate the coverage ranking of the plurality of application identifiers based on the simulated response from the at least one software application or the component associated with each application identifier.

15. A computer-implemented method for dynamically determining software application coverage, the computer-implemented method comprising:
receiving a plurality of application identifiers in an electronic network, wherein at least one application identifier of the plurality of application identifiers is associated with at least one of a software application or a component in the electronic network;
determining a potential vulnerability associated with the plurality of application identifiers;
generating a coverage score associated with each application identifier of the plurality of application identifiers, wherein the coverage score comprises an ability of at least one of the software application or the component to manage the potential vulnerability;
generating a coverage ranking of the plurality of application identifiers, wherein the coverage ranking is based on the coverage score associated with each application identifier of the plurality of application identifiers; and
storing the coverage ranking of the plurality of application identifiers in a coverage ranking database, wherein the coverage ranking of the plurality of application identifiers is based on the potential vulnerability.

16. The computer-implemented method of claim 15, wherein the coverage score comprises at least one of a vulnerability scanning score, a publishing score, or a source score.

17. The computer-implemented method of claim 15, wherein the computer-implemented method further comprises determining, based on the coverage ranking of the plurality of application identifiers, a high ranked application identifier subset, wherein the high ranked application identifier subset comprises at least one application identifier comprising an ability to overcome the potential vulnerability.

18. The computer-implemented method of claim 17, wherein the computer-implemented method further comprises:
generating, based on the high ranked application identifier subset, a coverage ranking interface component, wherein the coverage ranking interface component comprises the high ranked application identifier subset; and
transmitting the coverage ranking interface component to a user device associated with the electronic network to configure a graphical user interface of the user device.

19. The computer-implemented method of claim 15, wherein the potential vulnerability is based on at least one of a common data environment list or a common weakness enumeration list.

20. The computer-implemented method of claim 15, wherein the potential vulnerability is an attack.
